(19) United States
(12) Patent Application Publication
(10) Pub. No.: US 2026/0142226 A1
(43) Pub. Date: May 21, 2026

(54) NEW Li-CONDUCTOR PROTOTYPES IN THE Li-Mg-Na-C1 CHEMICAL SPACE FOR SOLID-STATE BATTERIES

(71) Applicant: SAMSUNG ELECTRONICS CO., LTD., Suwon-si (KR)

(72) Inventors: Qingjie LI, Arlington, MA (US); Chuhong WANG, Lexington, MA (US); Zijian CAI, Cambridge, MA (US); Michael CHON, Medford, MA (US); Yan WANG, Brookline, MA (US)

(73) Assignee: SAMSUNG ELECTRONICS CO., LTD., Suwon-si (KR)

(21) Appl. No.: 19/080,366

(22) Filed: Mar. 14, 2025

Related U.S. Application Data
(60) Provisional application No. 63/722,820, filed on Nov. 20, 2024.

(51) Int. Cl. H01M 10/0562; H01M 10/0525

(52) U.S. Cl. CPC H01M 10/0562; H01M 10/0525; H01M 2300/008

(57) ABSTRACT

A lithium-containing compound has the following parent formula: LiNaMg₂Cl₆ or LiNaMg₃Cl₈. In an embodiment, a lithium solid-state battery includes a cathode active material layer, an anode active material layer, and a solid electrolyte layer between the cathode active material layer and the anode active material layer, wherein the solid electrolyte layer includes the aforementioned lithium-containing compound. In an embodiment, the battery includes the aforementioned lithium-containing compound as a catholyte or as a coating for a cathode active material. In an embodiment, the anode active material layer is an alloy anode and the battery includes the aforementioned lithium-containing compound as an anolyte.

### CROSS-REFERENCE TO RELATED APPLICATION

This application is based on and claims priority from U.S. Provisional Application No. 63/722,820 filed on Nov. 20, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as cathode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in FIG. 1. In FIG. 1, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on discovering new solid-state lithium-ion conductors (SSLICs), including various oxide, sulfide, and halide materials. And most of them are focused on sulfide SSLICs with high ionic conductivities. Halide materials are believed to simultaneously show high Li ion conductivity and deformability. However, a very limited number of chloride materials were developed for SSBs.

Meanwhile, commercialization of SSBs crucially depends on the success of new solid electrolyte materials.

For solid-state electrolytes in SSBs, sulfide-based materials have high ionic conductivities (>10 mS/cm) but are not really safe (H₂S in air condition) and have limited electrochemical stability (for example, unstable against Li metal).

Oxide SSLICs, which show better electrochemical and chemical stability than sulfide SSLICs, have been largely limited in garnet-type materials. The ionic conductivities of reported oxide SSLICs are generally lower than those of sulfide SSLICs. Also, oxide SSLICs show relatively poor deformability which is crucial for processing and cycling performance.

Halide SSLICs are believed to show both high ionic conductivity and deformability, and reasonable electrochemical stability. Therefore, discovering new halide SSLICs is a promising solution for successful application of SSBs.

Solid state electrolyte materials with superionic conductivity and good deformability are desirable materials to form all-solid-state Li-metals batteries. However, it remains a significant challenge to simultaneously achieve high ionic conductivity at room temperature, good deformability for processing, and high electrochemical stability. Competition with currently established liquid electrolyte technologies is also a hurdle for widespread adoption. Currently, no Li-ion solid conductors satisfying all the above-mentioned requirements have been uncovered in the Li—Mg—Na—Cl chemical space. This disclosure focuses on a new composition in the Li—Mg—Na—Cl chemical space.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Mg—Na—Cl chemical space by high-throughput searching of novel structures using machine learning based evolutionary algorithms.

In this disclosure, novel lithium-containing chlorides include the following parent compositions: LiNaMg₂Cl₆, and LiNaMg₃Cl₈.

The lithium-containing compounds in this disclosure can be used as a solid electrolyte material for Li batteries. In addition, the lithium-containing compounds can be used as a catholyte or for coating a cathode active material, and they can also be used as an anolyte with an alloy anode.

This disclosure provides a high conductivity and good deformability solid electrolyte for use in Li solid-state batteries.

A first embodiment of the present disclosure provides a lithium-containing compound having the following parent formula: LiNaMg₂Cl₆ or LiNaMg₃Cl₈.

A second embodiment of the present disclosure provides a lithium-containing compound of the first embodiment, wherein the lithium-containing compound has the parent formula LiNaMg₂Cl₆.

A third embodiment of the present disclosure provides a lithium-containing compound of the first embodiment, wherein the lithium-containing compound has the parent formula LiNaMg₃Cl₈.

A fourth embodiment of the present disclosure provides a lithium-containing compound of the second embodiment, wherein the lithium-containing compound is LiNaMg₂Cl₆ crystallized in space group R-3.

A fifth embodiment of the present disclosure provides a lithium-containing compound of the third embodiment, wherein the lithium-containing compound is LiNaMg₃Cl₈ crystallized in space group P3 m1.

A sixth embodiment of the present disclosure provides a lithium solid-state battery comprising a cathode active material layer, an anode active material layer, and a solid electrolyte layer between the cathode active material layer and the anode active material layer, wherein the solid electrolyte layer comprises a lithium-containing compound of the first embodiment.

A seventh embodiment of the present disclosure provides a lithium solid-state battery of the sixth embodiment, wherein the solid electrolyte layer comprises a lithium-containing compound having the parent formula LiNaMg₂Cl₆.

An eighth embodiment of the present disclosure provides a lithium solid-state battery of the sixth embodiment, wherein the solid electrolyte layer comprises a lithium-containing compound having the parent formula LiNaMg₃Cl₈.

A ninth embodiment of the present disclosure provides a lithium solid-state battery of the seventh embodiment, wherein the solid electrolyte layer comprises a lithium-containing compound which is LiNaMg₂Cl₆ crystallized in space group R-3.

A tenth embodiment of the present disclosure provides a lithium solid-state battery of the eighth embodiment, wherein the solid electrolyte layer comprises a lithium-containing compound which is LiNaMg₃Cl₈ crystallized in space group P3m1.

An eleventh embodiment of the present disclosure provides a lithium solid-state battery comprising a cathode active material layer, an anode active material layer, and a solid electrolyte layer between the cathode active material layer and the anode active material layer, wherein the battery comprises a lithium-containing compound of the first embodiment as a catholyte or as a coating for a cathode active material.

A twelfth embodiment of the present disclosure provides a lithium solid-state battery of the eleventh embodiment, wherein the lithium-containing compound has the parent formula LiNaMg₂Cl₆.

A thirteenth embodiment of the present disclosure provides a lithium solid-state battery of the eleventh embodiment, wherein the lithium-containing compound has the parent formula LiNaMg₃Cl₈.

A fourteenth embodiment of the present disclosure provides a lithium solid-state battery of the twelfth embodiment, wherein the lithium-containing compound is LiNaMg₂Cl₆ crystallized in space group R-3.

A fifteenth embodiment of the present disclosure provides a lithium solid-state battery of the thirteenth embodiment, wherein the lithium-containing compound is LiNaMg₃Cl₈ crystallized in space group P3m1.

A sixteenth embodiment of the present disclosure provides a lithium solid-state battery comprising a cathode active material layer, an anode active material layer, and a solid electrolyte layer between the cathode active material layer and the anode active material layer, wherein the anode active material layer is an alloy anode and the battery comprises a lithium-containing compound of the first embodiment as an anolyte.

A seventeenth embodiment of the present disclosure provides a lithium solid-state battery of the sixteenth embodiment, wherein the lithium-containing compound has the parent formula LiNaMg₂Cl₆.

An eighteenth embodiment of the present disclosure provides a lithium solid-state battery of the sixteenth embodiment, wherein the lithium-containing compound has the parent formula LiNaMg₃Cl₈.

A nineteenth embodiment of the present disclosure provides a lithium solid-state battery of the seventeenth embodiment, wherein the lithium-containing compound is LiNaMg₂Cl₆ crystallized in space group R-3.

A twentieth embodiment of the present disclosure provides a lithium solid-state battery of the eighteenth embodiment, wherein the lithium-containing compound is LiNaMg₃Cl₈ crystallized in space group P3m1.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawing in which:

FIG. 1 shows an all solid-state battery.

FIG. 2 shows the crystal structures of materials of the present disclosure with the formula NaLiMg₂Cl₆ and NaLiMg₃Cl₈.

FIG. 3A shows the calculated powder diffraction pattern for NaLiMg₂Cl₆ crystallized in the space group R-3, and FIG. 3B shows the calculated powder diffraction pattern for NaLiMg₃Cl₈ crystallized in the space group P3m1.

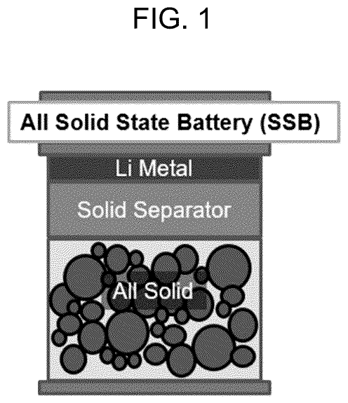

### DETAILED DESCRIPTION OF EXAMPLE EMBODIMENTS

The present disclosure demonstrates novel compositions (crystal structures) within the Li—Mg—Na—Cl chemical space with high Li-ion conductivity and good deformability.

In this disclosure, novel Li-ion prototypes within the Li—Mg—Na—Cl chemical space have the following parent formulas: LiNaMg₂Cl₆ and LiNaMg₃Cl₈.

In particular, the present disclosure focuses on presenting highly conductive and deformable Li-conductors of all-solid-state Li-metals batteries: NaLiMg₂Cl₆ and NaLiMg₃Cl₈, by applying a machine learning force field based evolutionary algorithm.

The new Li-ion conductor prototype NaLiMg₂Cl₆ may crystallize in space group R-3, while NaLiMg₃Cl₈ may crystallize in space group P3m1. These structure prototypes show reasonable thermodynamic (meta) stability with energy above hull 42 and 39 meV/atom, respectively.

The materials of the present disclosure show high predicted ionic conductivities of 22 and 272 mS/cm, respectively, at room temperature.

The materials of the present disclosure are also predicted to show low hardness of ˜3.2 GPa, indicating reasonable deformability.

Thus, in this disclosure, the new compositions may crystallize in the crystal structures set forth in the following Table 1, each with high Li-ion conductivity and good deformability.

TABLE 1

| | | | | | | | Electrochemical |
|---|---|---|---|---|---|---|---|
| | | space | Eₐ | σ (300K) | Hardness | Ehull | Stability Window vs. |
| Material_id | formula | group | (eV) | (mS/cm) | (GPa) | (meV/atom) | Li/Li+ (V) |
| aml-02-161603 | NaLiMg2Cl6 | R-3 | 0.18 | 21.89 | 3.3 | 42 | 0.89, 3.81 |
| aml-02-132595 | NaLiMg3Cl8 | P3m1 | 0.03 | 271.94 | 3.1 | 39 | 0.89, 3.81 |

Note:
Eₐ is the Li-ion diffusion activation energy, and σ is the Li-ion conductivity; hardness is a good indicator of deformability.

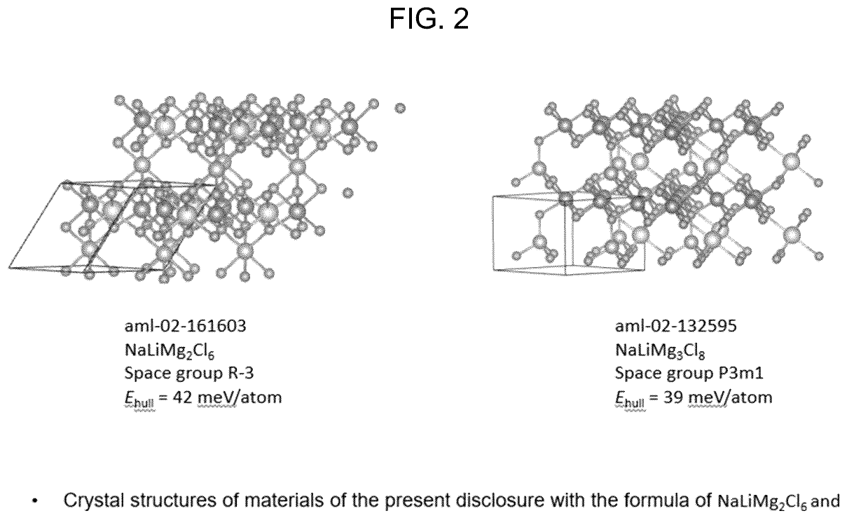

The crystal structures of materials of the present disclosure with the formula NaLiMg₂Cl₆ and NaLiMg₃Cl₈ are shown in FIG. 2. In FIG. 2, the green small spheres are Cl anions, the light green spheres are Li cations, the yellow spheres are Na cations, and the orange spheres are Mg cations.

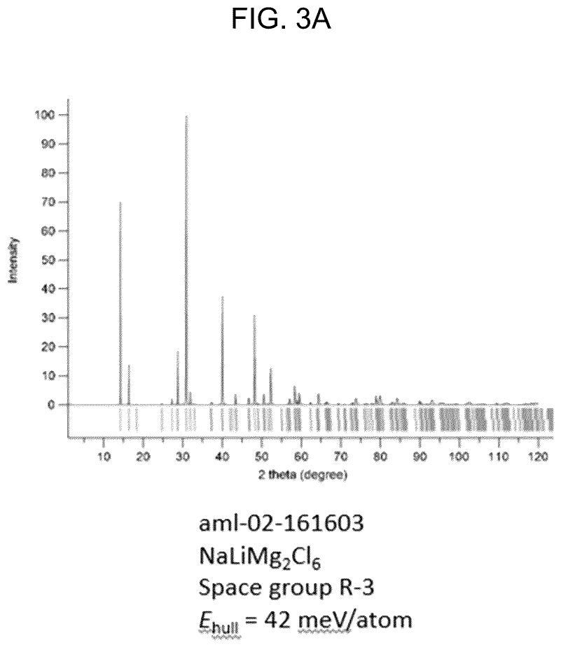

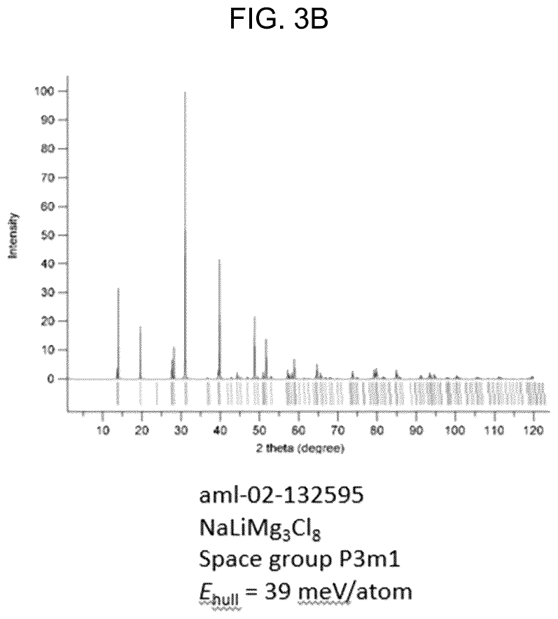

The calculated powder diffraction pattern for NaLiMg₂Cl₆ crystallized in the space group R-3 is shown in FIG. 3A, and the calculated powder diffraction pattern for NaLiMg₃Cl₈ crystallized in the space group P3m1 is shown in FIG. 3B.

A high-throughput evolutionary algorithm based materials search was conducted to discover novel prototypes for deformable Li-ion conductors as a potential solid electrolyte in an all solid Li-ion battery. The discovered novel prototype structures have been validated against thermodynamic stability, Li-ion conductivity at room temperature, and deformability.

The lithium-containing compounds in this disclosure can be made by a standard solid-state or mechanochemical ball-milling method.

In this method, precursor powders are combined in a certain ratio depending on the composition of the target material. As one example, precursors may consist of lithium chloride (LiCl), sodium chloride (NaCl), and magnesium chloride (MgCl₂).

The precursor mixture may be mixed by a method such as ball milling or planetary milling to produce a homogeneous mixture. Mixing may be done with a suitable solvent such as ethanol, isopropanol, ethylene glycol, hexane, or acetone to assist with the uniform dispersion of the precursors.

The precursor mixture may then be heat treated to an appropriate temperature (e.g., 300-1000° C.) for an appropriate period of time (e.g., 1-24 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., up to 1 hour) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing chlorides in this disclosure can be used, for example, as a solid electrolyte material for Li batteries.

In particular, this disclosure provides, for example, high conductivity and good deformability solid electrolytes for use in Li solid-state batteries.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing compound having the following parent formula: LiNaMg₂Cl₆ or LiNaMg₃Cl₈.

2. The lithium-containing compound of claim 1, wherein the lithium-containing compound has the parent formula LiNaMg₂Cl₆.

3. The lithium-containing compound of claim 1, wherein the lithium-containing compound has the parent formula LiNaMg₃Cl₈.

4. The lithium-containing compound of claim 2, wherein the lithium-containing compound is LiNaMg₂Cl₆ crystallized in space group R-3.

5. The lithium-containing compound of claim 3, wherein the lithium-containing compound is LiNaMg₃Cl₈ crystallized in space group P3 m1.

6. A lithium solid-state battery comprising a cathode active material layer, an anode active material layer, and a solid electrolyte layer between the cathode active material layer and the anode active material layer, wherein the solid electrolyte layer comprises a lithium-containing compound of claim 1.

7. The lithium solid-state battery of claim 6, wherein the solid electrolyte layer comprises a lithium-containing compound having the parent formula LiNaMg₂Cl₆.

8. The lithium solid-state battery of claim 6, wherein the solid electrolyte layer comprises a lithium-containing compound having the parent formula LiNaMg₃Cl₈.

9. The lithium solid-state battery of claim 7, wherein the solid electrolyte layer comprises a lithium-containing compound which is LiNaMg₂Cl₆ crystallized in space group R-3.

10. The lithium solid-state battery of claim 8, wherein the solid electrolyte layer comprises a lithium-containing compound which is LiNaMg₃Cl₈ crystallized in space group P3 m1.

11. A lithium solid-state battery comprising a cathode active material layer, an anode active material layer, and a solid electrolyte layer between the cathode active material layer and the anode active material layer, wherein the battery comprises a lithium-containing compound of claim 1 as a catholyte or as a coating for a cathode active material.

12. The lithium solid-state battery of claim 11, wherein the lithium-containing compound has the parent formula LiNaMg₂Cl₆.

13. The lithium solid-state battery of claim 11, wherein the lithium-containing compound has the parent formula LiNaMg₃Cl₈.

14. The lithium solid-state battery of claim 12, wherein the lithium-containing compound is LiNaMg₂Cl₆ crystallized in space group R-3.

15. The lithium solid-state battery of claim 13, wherein the lithium-containing compound is LiNaMg₃Cl₈ crystallized in space group P3 m1.

16. A lithium solid-state battery comprising a cathode active material layer, an anode active material layer, and a solid electrolyte layer between the cathode active material layer and the anode active material layer, wherein the anode active material layer is an alloy anode and the battery comprises a lithium-containing compound of claim 1 as an anolyte.

17. The lithium solid-state battery of claim 16, wherein the lithium-containing compound has the parent formula LiNaMg₂Cl₆.

18. The lithium solid-state battery of claim 16, wherein the lithium-containing compound has the parent formula LiNaMg₃Cl₈.

19. The lithium solid-state battery of claim 17, wherein the lithium-containing compound is LiNaMg₂Cl₆ crystallized in space group R-3.

20. The lithium solid-state battery of claim 18, wherein the lithium-containing compound is LiNaMg₃Cl₈ crystallized in space group P3 m1.
